(19) United States
(12) Patent Application Publication
(10) Pub. No.: US 2025/0158171 A1
(43) Pub. Date: May 15, 2025

(54) BATTERY PACK

(71) Applicant: SK On Co., Ltd., Seoul (KR)

(72) Inventors: Chae Won NA, Daejeon (KR); Jeong Won KIM, Daejeon (KR); Gang U LEE, Daejeon (KR); Kyu Hyun HAN, Daejeon (KR); Won Gab HWANG, Daejeon (KR)

(21) Appl. No.: 18/948,858

(22) Filed: Nov. 15, 2024

(30) Foreign Application Priority Data
Nov. 15, 2023 (KR) 10-2023-0157783
Sep. 2, 2024 (KR) 10-2024-0118581

(51) Int. Cl. H01M 10/658; H01M 10/613; H01M 50/204

(52) U.S. Cl. CPC H01M 10/658; H01M 10/613; H01M 50/204; H01M 2200/10

(57) ABSTRACT

The present disclosure relates to a battery pack including a plurality of battery cells, a pack case which accommodates the plurality of battery cells, a partition located inside the pack case and dividing an internal space of the pack case to form a cell accommodation space in which the plurality of battery cells are accommodated, a member accommodation space located adjacent to the cell accommodation space within the pack case, and an insertion member located in the member accommodation space and including fire-resistant particles.

### CROSS-REFERENCE TO RELATED PATENT APPLICATION

The present application claims priority under 35 U.S.C. § 119(a) to Korean patent application number 10-2023-0157783 filed on Nov. 15, 2023 and Korean patent application number 10-2024-0118581 filed on Sep. 2, 2024, the entire disclosure of which is incorporated by reference herein.

### BACKGROUND

### 1. Field

The present disclosure relates to a battery pack. Specifically, the present disclosure relates to a battery pack to delay thermal propagation (TP) during thermal runaway of a battery cell.

### 2. Description of the Related Art

Recently, due to fires and explosions which occur during the use of lithium secondary batteries, social concerns about the safety of battery use have been increasing. Based on these social concerns, one of the major development tasks of lithium secondary batteries recently is to eliminate instability such as fires and explosions caused by thermal runaway of battery cells.

In particular, a battery module/pack contains an empty space other than the battery cells, which are the energy source. If a fire occurs due to an external impact or a problem with a battery cell, the flame may spread to adjacent cells through the empty space, increasing the damage caused by the fire. Because this risk of fire could be the biggest obstacle to the electric vehicle market, research is ongoing into ways to reduce the spread of fire.

### SUMMARY OF THE INVENTION

First, according to one aspect of the present disclosure, an object is to delay propagation of high-temperature gas (e.g., off-gas) or heat inside a battery pack due to thermal runaway of one or more battery cells provided inside the battery pack.

Second, according to another aspect of the present disclosure, an object is to vent high-temperature gas generated in a battery cell that has experienced thermal runaway along an intended path.

Third, according to yet another aspect of the present disclosure, an object is to increase the stability and service life of a battery pack by increasing heat resistance or fire resistance.

A battery pack according to the present disclosure may be widely applied in the field of green technology such as electric vehicles, battery charging stations, energy storage systems (ESS), and other battery-based photovoltaics and wind power. In addition, the battery pack according to the present disclosure may be used for eco-friendly mobility, including electric vehicles and hybrid vehicles, to prevent climate change by suppressing air pollution and greenhouse gas emissions.

A battery pack according to the present disclosure may include: a plurality of battery cells; a pack case which accommodates the plurality of battery cells; a partition located inside the pack case and dividing an internal space of the pack case to form a cell accommodation space in which the plurality of battery cells are accommodated; a member accommodation space located adjacent to the cell accommodation space within the pack case; and an insertion member located in the member accommodation space and including fire-resistant particles.

According to an embodiment, the insertion member may further include a binder which binds the fire-resistant particles together.

According to an embodiment, the binder may melt above a predetermined allowable temperature, and the allowable temperature may be between 60° C. (degree Celsius) and 800° C.

According to an embodiment, a melting point of the fire-resistant particles may be higher than the allowable temperature.

According to an embodiment, the fire-resistant particles may be bound by the binder to form an outer shape of the insertion member.

According to an embodiment, the insertion member may further include an exterior material which accommodates the fire-resistant particles.

According to an embodiment, the exterior material may melt above a predetermined allowable temperature, and the allowable temperature may be between 60° C. and 800° C.

According to an embodiment, the exterior material may be formed into a predetermined shape.

According to an embodiment, the exterior material may be formed of a flexible material which is deformable according to a space in which the insertion member is disposed.

According to an embodiment, the fire-resistant particles may include a porous material, and a porosity of the porous material may be 1% (percent) or more and 99% or less.

According to an embodiment, the fire-resistant particles may include one of silicon dioxide and an organic silicon compound or a combination thereof.

According to an embodiment, the pack case may include a pack body having an opening in an upper part, accommodating the plurality of battery cells through the opening, and forming the cell accommodation space and the member accommodation space together with the partition, and a pack cover which is coupled to the pack body to close the opening.

According to an embodiment, the pack body may include a pack body bottom surface forming a bottom surface of the pack body, and a pack body side part which extends from an edge of the pack body bottom surface and extends toward the pack cover.

According to an embodiment, the member accommodation space may include a first member accommodation space formed by the plurality of battery cells and the pack body side part, and the insertion member may include a first insertion member which is located in the first member accommodation space.

According to an embodiment, the member accommodation space may further include a second member accommodation space located between the plurality of battery cells and the pack cover, and the insertion member may further include a second insertion member located in the second member accommodation space and formed in a different shape from the first insertion member.

According to an embodiment, the member accommodation space may further include a third member accommodation space located between the plurality of battery cells and the partition, and the insertion member may further include a third insertion member located in the third member accommodation space and formed in a different shape from the first insertion member and the second insertion member.

According to an embodiment, the member accommodation space may further include a sub member accommodation space located between the plurality of battery cells, the second insertion member, and the partition, and the insertion member may further include a sub insertion member located in the sub member accommodation space and formed in a different shape from the first insertion member and the second insertion member.

According to an embodiment, the pack body side part may include a first pack body side surface and a second pack body side surface extending from a pair of edges facing each other among edges of the pack body bottom surface toward the pack cover, and a first pack connection side surface and a second pack connection side surface which are connected to the first pack body side surface and the second pack body side surface and extend from another pair of edges facing each other of the pack body bottom surface toward the pack cover.

According to an embodiment, a volume occupied by the fire-resistant particles may be 1% or more of the volume of the member accommodation space.

According to an embodiment, a plurality of the insertion members may be provided, and the plurality of insertion members may be formed into different shapes depending on their locations.

According to an embodiment, the pack cover may further include a recessed part formed by recessing in a direction away from the pack body, the member accommodation space may include a recessed accommodation space formed in the recessed part, and the insertion member may include a cover insertion member located in the recessed accommodation space to surround at least a part of a detector which detects a current of the plurality of battery cells.

According to an embodiment, the battery pack according to the present disclosure may further include a power connection which is inserted through any side surface of the first pack body side surface, the second pack body side surface, the first pack connection side surface, and the second pack connection side surface and electrically connects the plurality of battery cells to an outside, and a controller which is located between the one side surface and the plurality of battery cells and controls the plurality of battery cells, the member accommodation space may include a controller accommodation space in which the controller is located between the pack case and the partition, and the insertion member may include a controller insertion member located in the controller accommodation space to surround at least a part of the controller.

First, according to an embodiment of the present disclosure, it is possible to delay propagation of high-temperature gas or heat inside a battery pack due to thermal runaway of one or more battery cells provided inside the battery pack.

Second, according to another embodiment of the present disclosure, it is possible to vent high-temperature gas generated in the battery cell that has experienced thermal runaway along an intended path.

Third, according to yet another aspect of the present disclosure, it is possible to increase the stability and service life of the battery pack by increasing heat resistance or fire resistance.

### BRIEF DESCRIPTION OF THE DRAWINGS

FIG. 1 is an example of a battery pack according to the present disclosure.

FIG. 2 is an example of a battery pack according to the present disclosure viewed from above.

FIG. 3 is another example of a battery pack according to the present disclosure viewed from above.

FIG. 4 is an exploded view of an example of a battery module included in a battery pack according to the present disclosure.

FIG. 5 is another example of a battery pack according to the present disclosure.

FIG. 6 is an example of a side view of a battery pack according to the present disclosure.

FIG. 7 is an example of an insertion member according to the present disclosure.

FIG. 8 is another example of an insertion member according to the present disclosure.

FIG. 9 is yet another example of an insertion member according to the present disclosure.

### DETAILED DESCRIPTION

Hereinafter, referring to the accompanying drawings, preferred embodiments of the present disclosure will be described in detail. The configuration of a device or a control method described below is intended to illustrate embodiments of the present disclosure and is not intended to limit the scope of the present disclosure, and reference numbers used identically throughout the specification represent identical components.

Specific terms used in the present specification are for illustrative purposes only and are not used to limit the present disclosure to the example embodiments.

For example, expressions such as “the same” and “identical” not only indicate a strictly identical state, but also indicate a state in which there is tolerance or a difference of the degree to which the same function is obtained.

For example, expressions indicating relative or absolute arrangements such as “in a direction”, “along a direction”, “parallel”, “perpendicular”, “centered”, “concentric”, or “coaxial” not only indicate the exact arrangements, but also indicate a state of relative displacement with tolerance or an angle or distance which provides the same function.

To describe the present disclosure, the following is explained based on a spatial orthogonal coordinate system with an X-axis, a Y-axis, and a Z-axis being orthogonal to each other. Unless otherwise specified, a Z direction refers to a vertical direction, and an X direction (or a first direction) refers to any one of the directions perpendicular to the vertical direction. Further, a Y direction (or a second direction) refers to a direction perpendicular to the Z direction and the X direction.

However, the X direction, Y direction, and Z direction mentioned below are provided for the purpose of explanation so that the present disclosure can be clearly understood, and it is to be understood that each direction may be defined differently depending on where the reference is placed.

The use of terms such as ‘first’, ‘second’, and ‘third’ before components mentioned below is only intended to avoid confusion regarding the components they refer to, and has nothing to do with the order, importance, or main-subordinate relationship between the components. For example, an invention which includes only a second component without a first component may be implemented.

As used herein, singular expressions include plural expressions unless the context clearly indicates otherwise.

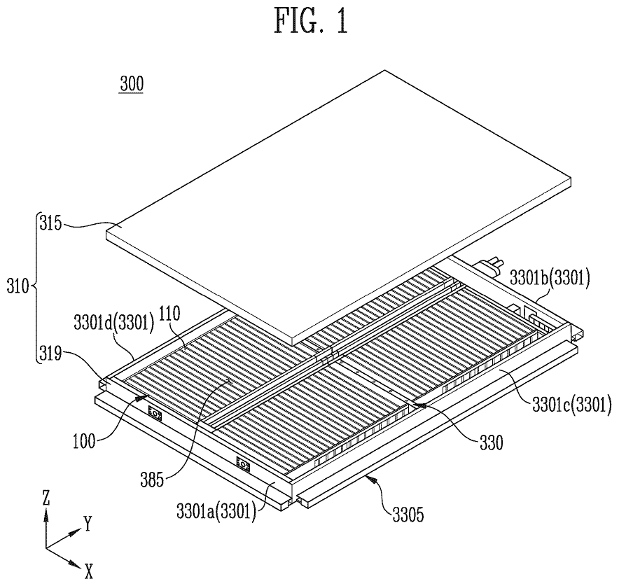

FIG. 1 is an example of a battery pack 300 according to the present disclosure.

Referring to FIG. 1, the battery pack 300 according to the present disclosure includes a plurality of battery cells 110, and a pack case 310 accommodating the plurality of battery cells 110.

The plurality of battery cells 110 may be stacked and arranged in a predetermined stacking direction (e.g., in the X or Y direction). In addition, the plurality of battery cells 110 may be grouped in a predetermined number to form at least one battery group (or a cell stack 100). The at least one battery group may be located in a space partitioned inside the pack case 310.

The pack case 310 may be formed of a metal material and may accommodate the plurality of battery cells 110 therein. The pack case 310 may include an opening 385 in an upper part, and include a pack body 319 which accommodates the plurality of battery cells 110 through the opening 385 and a pack cover 315 which is coupled to the pack body 319 to close the opening 385.

The pack cover 315 may form an internal space accommodating the plurality of battery cells with the pack body 319.

The pack body 319 may include a pack body bottom surface 3305 forming a bottom surface of the pack body 319 and a pack body side part 3301 extending from an edge of the pack body bottom surface 3305 and extending toward the pack cover 315.

The pack body bottom surface 3305 forms a bottom surface of the internal space or the bottom surface of the pack body 319, and may support the plurality of battery cells 110.

The pack body side part 3301 forms side surfaces of the internal space, and may extend from edges of the pack body bottom surface 3305 toward the opening 385.

Referring to FIG. 1, since the pack body bottom surface 3305 is a square panel, the pack body side part 3301 may include four side surfaces.

In other words, the pack body side part 3301 may include a first pack body side surface 3301c and a second pack body side surface 3301d which extend from a pair of facing edges of the pack body bottom surface 3305 toward the pack cover 315, and a first pack connection side surface 3301a and a second pack connection side surface 3301b which are connected to the first pack body side surface 3301c and the second pack body side surface 3301d and extend toward the pack cover 315 from a pair of facing edges of the pack body bottom surface 3305.

If the shape of the pack body bottom surface 3305 changes, the number of edges of the pack body bottom surface 3305 may change, and thus the number of side surfaces of the pack body side part 3301 may also change accordingly.

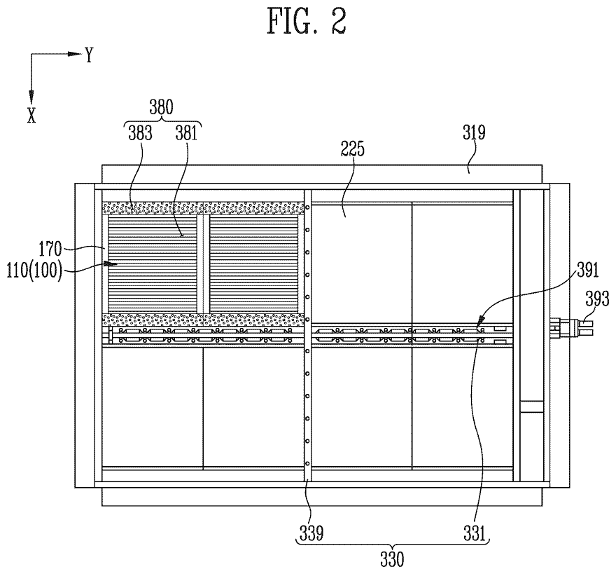

The battery pack 300 may further include a partition 330 for partitioning the internal space formed by the pack body 319 and the pack cover 315. The partition 330 may be a metal frame and separate the internal space so as to be divided by each battery group. The separated internal space is called a separate arrangement space (380, see FIG. 2), and the separate arrangement space 380 may include a cell accommodation space (381, see FIG. 2) which accommodates the plurality of battery cells and a member accommodation space (383, see FIG. 2) located adjacent to the cell accommodation space 381. The cell accommodation space 381 and the member accommodation space 383 may be connected to each other.

In addition, even if the interior space is separated, each separate space may not be an isolated space, but each separate space may be connected to each other. Unless otherwise specified in the present specification, even if the internal space is partitioned, the partitioned spaces are not isolated and separated spaces but are spaces that may be connected to each other.

FIG. 2 is an example of the battery pack 300 according to the present disclosure viewed from above.

Referring to FIG. 2, the plurality of battery cells 110 may be grouped by the predetermined number to form the cell stack 100. The cell stack 100 may refer to an assembly in which the predetermined number of battery cells 110 are electrically connected using a first bus bar 170.

Referring to FIG. 2, the cell stack 100 may be stacked in a predetermined stacking direction (e.g., in the X direction).

The cell stack 100 may be located in the separate arrangement space 380 formed in the battery pack 300.

The battery pack 300 according to the present disclosure may further include an accommodation cover 225 positioned between the cell stack 100 and the pack cover 315 to cover the cell stack 100 after the cell stack 100 is accommodated in the separate arrangement space 380. For reference, in order to explain the cell stack 100 being exposed in FIG. 2, FIG. 2 illustrates an example of the battery pack 300 with a part of the accommodation covers 225 removed.

As described above, the battery pack 300 may include the separate arrangement space 380 accommodating the plurality of battery cells 110 in the partition. Further, the separate arrangement space 380 may include the cell accommodation space 381 accommodating the cell stack 100 and the member accommodation space 383 located adjacent to the cell accommodation space.

The member accommodation space 383 refers to an empty space in the separate arrangement space 380 excluding the cell accommodation space 381.

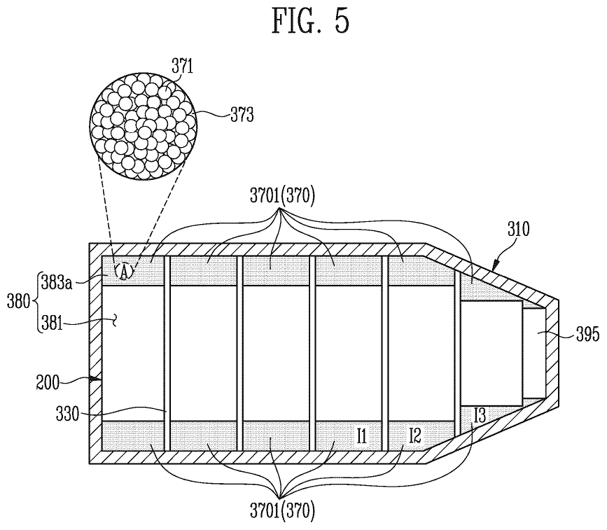

In addition, the battery pack 300 according to the present disclosure may further include a power connection 393 electrically connecting the outside of the pack case 310 with the plurality of battery cells 110. More specifically, the battery pack 300 according to the present disclosure may further include the power connection which is inserted through any side surface of the first pack body side surface 3301c, the second pack body side surface 3301d, the first pack connection side surface 3301a, and the second pack connection side surface 3301b and electrically connects the plurality of battery cells 110 to the outside; and a controller (395, see FIG. 5) which is positioned between the one side surface (3301a, 3301b, 3301c, 3301d) and the plurality of battery cells (110) and controls the plurality of battery cells 110.

In addition, the battery pack 300 according to the present disclosure may include the first busbar 170 which electrically connects the plurality of battery cells 110 grouped in the predetermined number and stacked, and a second busbar 391 which connects the first busbar 170 and the power connection 393.

The second busbar 391 may electrically connect the cell stacks 100 by viewing the cell stack 100 as one unit. The controller 395 may be located between the power connection 393 and the second busbar 391, and may detect status information including a voltage of the plurality of battery cells 110 and control the plurality of battery cells 110.

In addition, the partition 330 may form the separate arrangement space 380 by dividing the internal space of the pack case 310. In other words, the cell accommodation space 381 and the member accommodation space 383 may be formed by the partition 330 and the pack case 310. For this purpose, the partition 330 may include a first frame 331 dividing the internal space in the first direction and a second frame 339 dividing the interior space in the second direction perpendicular to the first direction. In other words, the partition 330 may include the first frame 331 and the second frame 339 to divide the internal space formed by the pack case 310 horizontally and vertically when viewed from the opening 385.

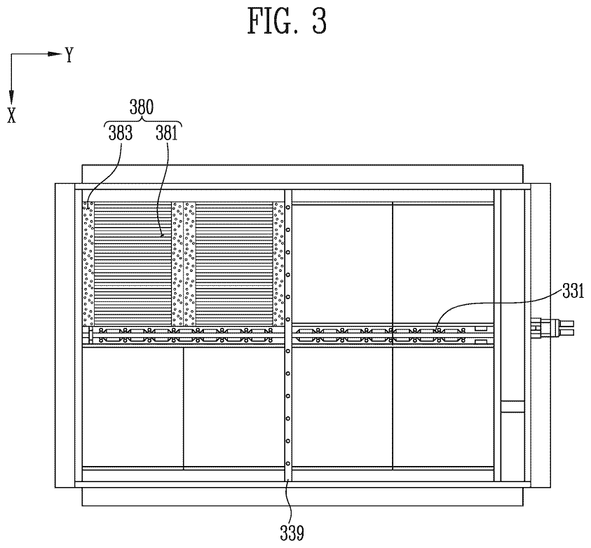

FIG. 3 is another example of the battery pack 300 according to the present disclosure viewed from above.

FIG. 2 shows the example in which the member accommodation space 383 is located perpendicular to the stacking direction of the plurality of battery cells 110 or the stacking direction of the battery cells 110 forming the cell stack 100. On the other hand, FIG. 3 shows an example in which the member accommodation space 383 is located side by side with the stacking direction.

Referring to FIGS. 2 and 3, the member accommodation space 383 may be connected with the cell accommodation space 381, and the member accommodation space 383 refers to a space in the separate arrangement space 380 formed by the partition, excluding the cell accommodation space 381. The member accommodation space 383 is exaggerated for illustrative purposes.

Referring to FIGS. 2 and 3, the member accommodation space 383 may be a space which takes into consideration the convenience of assembly and other members connected to the plurality of battery cells 110 when accommodating the plurality of battery cells 110 in the pack body 319. Therefore, the size of the member accommodation space 383 does not need to be large, but it may be a space which is inevitably formed.

If thermal runaway occurs in at least one battery cell 110 among the plurality of battery cells 110 and high-temperature gas or flame spread to the member accommodation space 383, the high-temperature gas or flame may quickly spread to other battery cells 110 and further to the entire battery pack 300 through the member accommodation space 383.

Therefore, it is necessary to delay or prevent the propagation of high-temperature gas or flame through the member accommodation space 383. To this end, the battery pack 300 according to the present disclosure includes an insertion member (370, see FIG. 5) located in the member accommodation space 383.

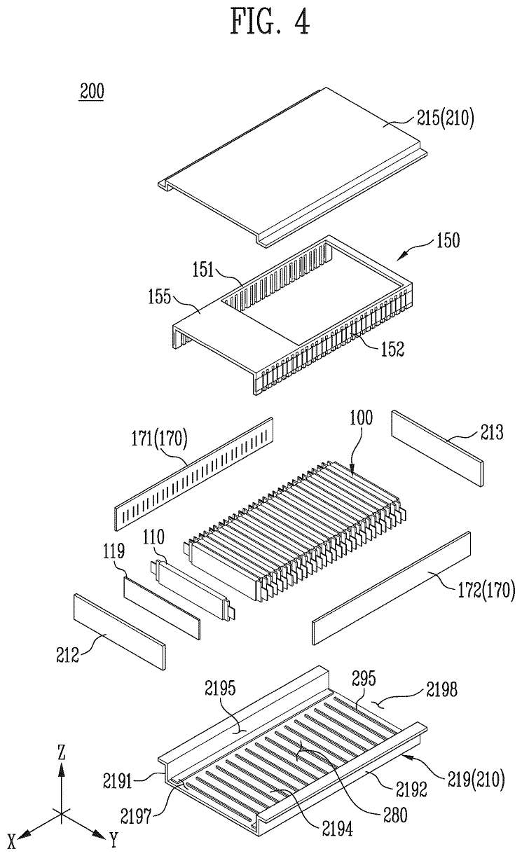

FIG. 4 is an exploded view of an example of a battery module 200 included in the battery pack 300 according to the present disclosure.

Referring to FIG. 4, the battery module 200 may include the plurality of battery cells 110, the first bus bar 170 electrically connected to the plurality of battery cells 110, and a module case 210 which accommodates the plurality of battery cells 110 and the first bus bar 170 therein.

The module case 210 may include a module body 219 forming a part of a module space 280 which accommodates the plurality of battery cells 110 and a module cover 215 which is coupled to the module body 219 to form the module space 280 together.

Inside the module body 219, the plurality of battery cells 110 may be located overlapping along a predetermined stacking direction (e.g., the X direction).

More specifically, the module case 210 may further include a module body 219 which includes an opened upper surface 2195 and accommodates the plurality of battery cells 110 through the opened upper surface 2195, and a module cover 215 which is coupled to the module body 219 and closes the opened upper surface 2195.

Therefore, the module cover 215 may be coupled to the module body 219 to form an upper surface of the module space 280 or the upper surface of the module case 210. In other words, the module cover 211 is coupled to the module body 219 to close the opened upper surface 2195 of the module body 219, and together with the module body 219, forms the module space 280.

The module space 280 is formed inside the module body 219 and may include a space accommodating the cell stack 100.

In addition, the module body 219 may be provided in a channel shape or U-shape with an open upper part. Referring to FIG. 2, two side surfaces 2197 and 2198 facing each other along the X direction of the side surfaces of the module body 219 may also be opened.

In other words, the module body 219 may include a module body bottom surface 2194 forming a bottom surface of the module space 280 and module body side surfaces 2191 and 2192 extending toward the module cover 211 from edges (not shown) which are provided side by side along the stacking direction among edges of the module body bottom surface 2194. The free end of the module body side surface (2191 or 2192) may be bent to form a flange (not shown). This is for easy coupling with the module cover 211.

Referring to FIG. 4, the height of the module body 219 may be less than the height of the plurality of battery cells 110. However, this is merely an example, and the height of the module body 219 may be greater than the height of the plurality of battery cells 110.

Referring to FIG. 4, a thermal barrier member 119 is shown as being provided at one end of the cell stack 100, but this is merely an example. In other words, the cell stack 100 may further include buffer members or thermal barrier members 119 located between the plurality of battery cells 110. The thermal barrier members 119 may be located between at least some of the plurality of battery cells 110.

The thermal barrier member 119 may serve as a thermal barrier, in the event of thermal runaway of one battery cell 110, to prevent flame or heat from spreading to adjacent battery cells 110.

The plurality of battery cells 110 and the plurality of thermal barrier members 119 may be provided and stacked in a predetermined position. For example, referring to FIG. 2, an example is illustrated in which long edges of the plurality of battery cells 110 are arranged side by side with the Y direction. Therefore, the plurality of battery cells 110 and the plurality of thermal barrier members 119 shall be located to overlap in the X direction.

The heat barrier member 119 may be formed of a fire-resistant (heat-resistant or flame-retardant) material. For example, the thermal barrier member 119 may include a fire-resistant polymer, or a material such as mica.

In addition, referring to FIG. 4, the battery module 200 may further include end plates 212 and 213 at both ends of the cell stack 100 along the stacking direction. The end plates 212 and 213 may be provided at both ends of the cell stack 100 or connected to the two side surfaces 2197 and 2198 of the module body 219.

The end plates 212 and 213 are intended to prevent the two side surfaces of the cell stack 100 from being exposed to the outside.

In addition, the battery module 200 may include first busbars 171 and 172 electrically connected to the plurality of battery cells 110. Further, the battery module 200 may further include busbar frames 151, 152, and 155 supporting the first busbars 171 and 172 and the plurality of battery cells 110. The first bus bars 171 and 172 and the bus bar frames 151, 152, and 155 may be collectively referred to as a busbar assembly 150. In other words, the busbar assembly 150 may include the first busbars 171 and 172 electrically connected to the plurality of battery cells 110.

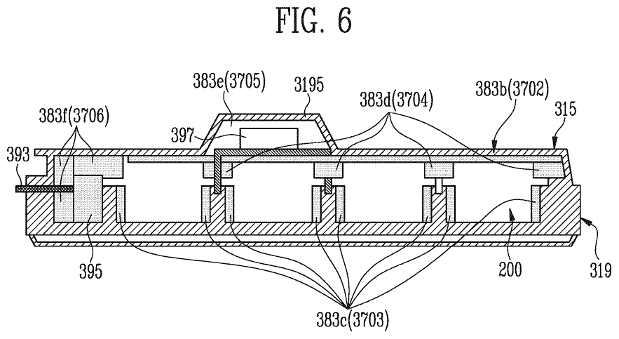

The first busbars 171 and 172 may connect the stacked plurality of battery cells 110 in series or parallel so that a predetermined voltage may be output. Further, the battery pack 300 may further include the second busbar 391 located inside the pack case 310 to electrically connect the first busbars 171 and 172 and the power connection (393, see FIG. 6). The second busbar 391 may connect between the battery module 200 and the power connection 393, and between the battery modules 200, so that a voltage at the battery pack 300 is output above a predetermined voltage. To this end, the battery pack 300 may further include the controller (395, see FIG. 5) positioned between the second bus bar 391 and the power connection 393 to control the plurality of battery cells 110.

The busbar frames 151, 152, and 155 may be electrically connected to the outside and may store electrical energy in the plurality of battery cells 110 (or charge), or supply electrical energy stored in the plurality of battery cells 110 to the outside (or discharge).

The busbar assembly 150 may include the first busbar frame 151 and the second busbar frame 152 extending along the stacking direction of the plurality of battery cells 110 with the plurality of battery cells 110 interposed therebetween.

Further, the busbar assembly 150 may further include a support frame 155 positioned on one side of the busbar assembly 150 and connecting the first busbar frame 151 and the second busbar frame 152.

Referring to FIG. 4, the busbar assembly 150 may be located on each side of the plurality of battery cells 110. On the other hand, the busbar assembly 150 may be located on one side (e.g., an upper side) of a main body 115.

In other words, if each of cathode and anode electrodes provided in the plurality of battery cells 110 is connected to one of the first bus bar 170 and the second bus bar 391, the first bus bar 170 and the second bus bar 391 may be located anywhere.

In addition, the support frame 155 may play a role in preventing deformation of and supporting the first bus bar frame 151 and the second bus bar frame 152. Further, a part of an electrical device for sensing and controlling the plurality of battery cells 110 may be disposed on the support frame 155.

Referring to FIG. 4, the shape of the busbar assembly 150 may be a tunnel shape. Further, along the stacking direction, the length of the first bus bar frame 151 and the second bus bar frame 152 may be longer than the length of the support frame 155.

In other words, the support frame 155 may be connected to the first bus bar frame 151 and the second bus bar frame 152 to cover an upper part of the plurality of battery cells 110. The support frame 155 may cover only a portion of the upper part of the plurality of battery cells 110 or may cover the entire upper part.

The first bus bar 170 and the second bus bar 391 may be positioned further away from the plurality of battery cells 110 than the first bus bar frame 151 and the second bus bar frame 152, respectively. In other words, the first bus bar 170 and the second bus bar 391 may be positioned closer to the module body side surfaces 2191 and 2192 than the first busbar frame 151 and the second busbar frame 152.

In addition, the battery module 200 may further include a heat dissipation part 295 positioned between the module body bottom surface 2194 and the plurality of battery cells 110 to transfer heat generated from the plurality of battery cells 110 to the outside of the battery module 200. The heat dissipation part 295 may be made of an adhesive material having thermal conductivity, such as a heat dissipation adhesive. Therefore, through the heat dissipation part 295, it may be possible to bond the plurality of battery cells 110 to the module body bottom surface 2194. For this purpose, the heat dissipation part 295 may be sprayed or applied on the module body bottom surface 2194.

FIG. 5 is another example of the battery pack 300 according to the present disclosure.

As described above, when thermal runaway occurs in any one battery cell 110 of the plurality of battery cells 110, high-temperature gas (off-gas) or flame may propagate to other adjacent battery cells 110 from the battery cell 110 where the thermal runaway has occurred.

The high-temperature gas or flame may be propagated or discharged not only to the battery module 200 but also into the internal space of the pack case 310. The battery pack 300 according to the present disclosure may have a cell to pack (CTP) structure without the battery module 200 (see FIG. 1). Therefore, there is a possibility that the high-temperature gas or flame may propagate rapidly along the member accommodation space 383 in the internal space. The battery pack according to the present disclosure may delay (mitigate) the propagation of high-temperature gas or flame to another location by positioning the insertion member 370 in the member accommodation space 383 to reduce the empty space in the member accommodation space 383.

To this end, the battery pack 300 according to the present disclosure may include the plurality of battery cells 110, the pack case 310 accommodating the plurality of battery cells 110, the partition 330 located inside the pack case 310 and dividing the internal space of the pack case 310 to form the cell accommodation space 381 in which the plurality of battery cells 110 are accommodated, the member accommodation space 383 located adjacent to the cell accommodation space 381 in the pack case 310, and the insertion member 370 located in the member accommodation space 383 and including fire-resistant particles.

The insertion member 370 may include a binder 373 which binds the fire-resistant particles 371 together.

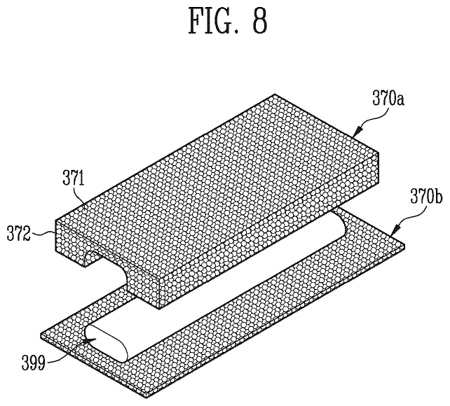

Alternatively, the insertion member 370 may further include an exterior material (372, see FIG. 8) which accommodates the fire-resistant particles 371. In other words, the fire-resistant particle 371 may be accommodated in the exterior material 372 which restricts movement of the fire-resistant particle 371 without the binder 373.

The exterior material 372 may be formed into a predetermined shape corresponding to the member accommodation space 363 in order to be inserted into the member accommodation space 363.

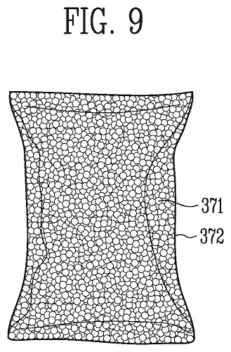

Alternately, the exterior material 372 may be formed of a flexible material which is deformable according to the member accommodation space 383 in which the insertion member 370 is disposed. In other words, the exterior material 372 may be formed of a flexible material without a specific shape. The exterior material 372 will be described later with respect to FIGS. 8 and 9.

The insertion member 370 may be positioned in the member accommodation space 383 to fill the member accommodation space 383. To simplify a process of positioning the insertion member 370 in the member accommodation space 383, the insertion member 370 may be formed in a size and shape which can be inserted into the member accommodation space 383. For example, if the member accommodation space 383 is a hexahedron with a length of a side of 5 cm, the insertion member 370 may be formed into a hexahedron with a length of an edge of 5 cm or less. This is because an assembly error between the insertion member 370 and the member accommodation space 383 is taken into consideration.

Further, the shape of the insertion member 370 may vary depending on the shape of the battery pack 300 and the location of the member accommodation space 383.

Specifically, the member accommodation space 383 may include a first member accommodation space 383a formed by the plurality of battery cells 110 and the pack body side part 3301, and the insertion member 370 may include a first insertion member 3701 located in the first member accommodation space 383a.

For reference, since the first insertion member 3701 corresponding to the shape of the first member accommodation space 383a is positioned at the location of the first member accommodation space 383a, different reference numerals are simultaneously indicated at the same location. Unless otherwise specified, the following drawings are shown in a similar way for other member accommodation spaces and other insertion members.

As described above, the shape of the first insertion member 3701 may vary depending on where it is located inside the battery pack 300. Referring to FIG. 5, if a side of the pack case 310 which is smaller than other sides of the pack case 310 is called a front side, and its opposite side is called a rear side, the size and shape of the first member accommodation space 383a adjacent to the front side may be different from the size and shape of the first member accommodation space 383a adjacent to the rear side. Therefore, the shape of the first insertion member (3701, I3) inserted into the first member accommodation space 383a adjacent to the front side may be different from the shape of the first insertion member (3701, I1) inserted into the first member accommodation space 383a adjacent to the rear side and the shape of the first insertion member (3701, I2) positioned therebetween.

Referring to the enlarged drawing of area A of the first insertion member 3701, the first insertion member 3701 may include the fire-resistant particles 371 and the binder 373 which binds the fire-resistant particles 371 and forms the outer shape of the first insertion member. This may also be applied to other insertion members, which will be described later.

In other words, the insertion member 370 may form an outer shape or a predetermined three-dimensional shape of the insertion member 370 by binding the fire-resistant particles 371 by the binder 373.

Referring to FIG. 5, a plurality of the fire-resistant particles 371 may be provided. For reference, the fire-resistant particle 371 is shown in an exaggerated size for explanation and simplified in shape to a sphere, but may have an amorphous shape.

Preferably, the insertion member 370 may include the plurality of fire-resistant particles 371 and the binder 373 which binds the plurality of fire-resistant particles 371 among the plurality of fire-resistant particles 371 to form the predetermined three-dimensional shape.

The plurality of fire-resistant particles 371 may be solid fillers provided in the form of solid particles, powders, granules, pellets, or beads. This is to prevent or delay flame propagation or heat propagation through the member accommodation space 383 in the event of thermal runaway of any battery cell 110.

The size of the fire-resistant particle 371 may have micro-size. These micro-sized fire-resistant particles 371 may be called micro beads or micro granules.

The size of the fire-resistant particle 371 may be preferably 2 μm (micrometer) or more and may be less than or equal to the length or thickness of one battery cell 110 along the stacking direction.

The size of the fire-resistant particle 371 may be the size of the diameter when assuming a spherical shape with the radius being the distance from the center (or center of gravity) of the fire-resistant particle 371 to the outermost outer periphery. Therefore, the size of the fire-resistant particle 371 may be the maximum outer diameter of the fire-resistant particle 371. Alternatively, the size of the fire-resistant particle 371 may be an average value calculated by measuring the fire-resistant particle 371 from multiple directions. This may also be applied when the fire-resistant particle 371 is in the form of a particle.

The reason why the size of the fire-resistant particle 371 should be 2 μm or more is to take into account a void of a welding bead (not shown) formed in a part that is welded and coupled inside the battery pack (e.g., the part where the first bus bar 170 and the plurality of battery cells are coupled). This is because when the size of the fire-resistant particle 371 is smaller than the void of the welding bead, it may unintentionally move from the member accommodation space 383 to the cell accommodation space 381 through the void of the welding bead.

Therefore, the size of the fire-resistant particle 371 may be greater than the size of the void formed in the welding bead.

Further, the fire-resistant particles 371 are not necessarily defined by a single size or material, but may be in the form of a mixture of fire-resistant particles 371 of various sizes or materials.

The melting point of the fire-resistant particle 371 may preferably be higher than a preset allowable temperature (or a predetermined temperature) to be described later.

The binder 373 may begin to melt when the allowable temperature is reached. For example, the allowable temperature may be between 60° C. (degrees Celsius) and 800° C. As another example, the allowable temperature may be 200° C.

Therefore, the melting point of the fire-resistant particle 371 should be higher than the allowable temperature. In other words, the melting point of the fire-resistant particle 371 may be higher than the temperature at which the binder 373 begins to melt.

Further, the melting point of the fire-resistant particle 371 may be higher than the ignition point of the plurality of battery cells 110. The ignition point of the plurality of battery cells 110 may be the temperature at which venting occurs in the battery cells 110. Alternatively, it may be the temperature of the electrolyte contained inside the battery cell 110 when the case of the battery cell 110 is damaged or opened in a thermal runaway situation.

Therefore, when any one of the battery cells 110 starts to experience thermal runaway, the binder 373 starts to melt, but the fire-resistant particle 371 may maintain its solid form. This is to prevent the fire-resistant particle 371 from burning or melting.

For example, even if thermal runaway of the battery cell 110 occurs, the fire-resistant particle 371 will not burn or melt, and the outer shape of the fire-resistant particle 371 may be maintained without significant change.

The fire-resistant particle 371 may include a porous material. The porous material is a material which contains pores inside its structure. The shape of the pores may be irregular or amorphous. Specifically, the fire-resistant particles 371 may include silica gel in particle or powder form.

For example, the fire-resistant particles 371 may include a porous material, and the porosity of the porous material may be greater than or equal to 1% (percent) and less than or equal to 99%.

As another example, the porosity of the fire-resistant particles 371 may be greater than or equal to 20% and less than or equal to 30%.

In addition, the fire-resistant material may be an inorganic compound. In other words, the fire-resistant particle 371 may include a fire-resistant material formed from an inorganic compound. The inorganic compound may be alum (K₂SO₄·Al₂(SO₄)₃·24H₂O), borax (Na₂B₄O₇·10H₂O), lime water (Ca(OH)₂ aqueous solution), quicklime (CaO), milk of lime (white emulsion made by mixing Ca(OH)₂ with water), slaked lime (Ca(OH)₂), washing soda (Na₂CO₃·10H₂O), apatite (Ca₅(PO₄)₃OH), baking powder (a mixture of NaHCO₃ and salts of tartaric acid), baking soda (NaHCO₃), sodium thiosulfate pentahydrate (Na₂S₂O₃·5H₂O), silica (or silicon dioxide (SiO₂)), alumina (or aluminum oxide (Al₂O₃)), calcium oxide (CaO), calcium sulfate (CaSO₄), calcium chloride (CaCl₂), sodium carbonate (Na₂CO₃), potassium chloride (KCl), magnesium oxide (MgO), zirconium oxide (ZrO₂), chromium oxide (Cr₂O₃), aluminum hydroxide (Al(OH)₃), antimony trioxide (Sb₂O₃), antimony pentoxide (Sb₂O₅), magnesium hydroxide (Mg(OH)₂), any one compound selected from the group including a zinc borate compound, a phosphorus compound, a nitrogen-based guanidine compound, or a molybdenum compound, or a mixture thereof.

For example, assuming that the fire-resistant particle 371 is formed of silica (silicon dioxide) and considering the melting point of silica (1713° C. (degree Celsius)), the fire-resistant particle 371 will be able to minimize propagation of the heat or off-gas generated when thermal runaway occurs to other places. In addition, the fire-resistant particle 371 will remain unchanged in its shape under the thermal runaway situation of the battery cell.

As another example, the fire-resistant particle 371 may be formed of silica gel. The silica gel is a powder-like porous material made by treating an aqueous solution of sodium silicate (Na₂SiO₃) with acid. Specifically, it may be obtained by mixing sodium silicate and an aqueous inorganic acid solution (e.g., sulfuric acid) to form a silica hydrosol and then hardening the hydrosol into a hydrogel. Considering the typical preparation method of the silica gel described above, the main component (component accounting for 50% or more) of the silica gel is silicon dioxide, and other components may further include aluminum oxide, iron (Ill) oxide (Fe₂O₃ or ferric oxide) or sodium. Therefore, the melting point of the silica gel may be approximately 1600° C. or higher.

Preferably, the silica gel may contain 90% or more of silicon dioxide. Further, since the silica gel is a porous material, the porosity of the fire-resistant particles 371 may be 20% or more and 30% or less.

In addition, the fire-resistant particle 371 may include either silicon dioxide or an organosilicon compound, or a combination thereof.

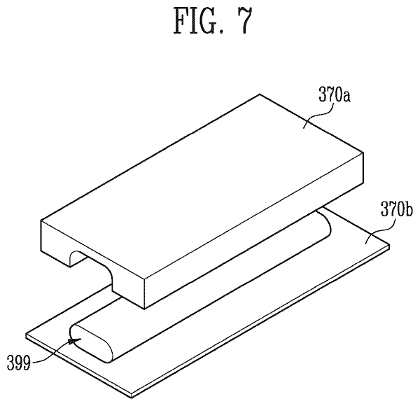

The organosilicon compound may refer to a compound in which silicon is bonded to an organic group. An example of the organosilicon compound is silicone foam. The silicone foam may be injected into the exterior material (or packaging material) and shaped into a foamed form, or may be used by filling the exterior material (or packaging material) with a foam that has hardened into a bead shape as shown in FIGS. 6 and 7. However, this is merely an example, and the organosilicon compound is not limited to the silicone foam in the present disclosure.

The binder 373 may melt at or above a preset allowable temperature. In other words, if thermal runaway occurs in at least one battery cell 110 among the plurality of battery cells 110 and the temperature rises, the temperature around the battery cell 110 in which the thermal runaway occurs will rise. Here, when the temperature of the binder 373 reaches the allowable temperature, the binder 373 may begin to melt. For example, the allowable temperature may be between 60° C. and 800° C.

As another example, the allowable temperature may be 200° C.

If the binder 373 melts above the allowable temperature, the outer shape of the insertion member 270 will not be maintained. Accordingly, at least some of the plurality of fire-resistant particles 371 which maintained a cylindrical shape by the binder 373 may be changed into a freely movable state.

In other words, when the binder 373 melts above the allowable temperature, the fire-resistant particles 371 may be dispersed one by one. In general, the fire-resistant particles 371 may be stacked from the bottom inside the member accommodation space 383 by their own weight unless there is a large external impact. In other words, when the binder 373 melts above the allowable temperature and the restraint of the fire-resistant particles 371 is released, the fire-resistant particles 371 may be piled up on the pack body bottom surface 3305 or a portion of the insertion member 370 which has not yet melted by their own weight. If the binder 373 is all melted, the fire-resistant particles 371 will fill the member accommodation space 383 from the pack body bottom surface 3305 by their own weight.

Even if the binder 373 is all melted, in order for the fire-resistant particles 371 to perform the function of delaying the propagation of high-temperature gas or flame, the volume occupied by the fire-resistant particles 371 in the member accommodation space 383 may be 1% or more of the volume of the member accommodation space 383.

Therefore, regardless of the shape in which the insertion member 370 is formed, the volume of the fire-resistant particles 371 may be 1% or more of the volume of the member accommodation space 383 in which the insertion member 370 is positioned.

In other words, the volume occupied by the fire-resistant particles 371 may be 1% or more of the volume of the member accommodation space 383.

This is because, considering the volume of the member accommodation space 383, even if the volume of the fire-resistant particles 371 is only 1% of the volume of the member accommodation space 383, it is possible to delay or block the thermal propagation occurring inside the battery pack 300.

On the other hand, the insertion member 370 may be formed into a desired shape through the binder 373, and the moisture-resistant or moisture-proof effect of the insertion member 370 may be improved by obtaining the effect of coating the outer surface of the insertion member 370 with the binder 373.

The material of the binder 373 may be a polymer such as resin. Further, the binder 373 may also be a heat-resistant or flame-retardant material which does not melt to the allowable temperature.

In addition, the fire-resistant particle 371 may be formed from other materials other than silica gel as long as they have porosity and flame retardancy (heat resistance or fire resistance).

As another example, the fire-resistant particle 371 may refer to a polymer material having a V-0 rating in the 94V test (Vertical Burning Test) of UL (Underwriter's Laboratory), which is a flame retardant standard for polymer materials.

Specifically, the fire-resistant particle 371 may include a flame-retardant polymer. The flame-retardant materials include phosphorus-based, halogen-based, and inorganic flame retardants, and preferably, in the case of phosphorus-based flame retardant materials, may include phosphate compounds, phosphonate compounds, phosphinate compounds, phosphine oxide compounds, phosphazene compounds, and metal salts thereof. They may be used alone or in a mixture of two or more.

As another specific embodiment, the phosphorus-based flame retardants may be diphenyl phosphate, diaryl phosphate, triphenyl phosphate, tricresyl phosphate, trizyrenyl phosphate, tri(2,6-dimethylphenyl) phosphate, tri(2,4,6-trimethylphenyl) phosphate, tri(2,4-dietercialbutylphenyl) phosphate, tri(2,6-dimethylphenyl) phosphate, bisphenol-A-bis(diphenyl phosphate), resorcinol bis[bis(2,6-dimethylphenyl)phosphate], resorcinol bis[bis(2,4-ditermerybutylphenyl)phosphate], hydroquinone bis[bis(2,6-dimethylphenyl)phosphate], hydroquinone bis[bis(2,4-ditermesteributylphenyl)phosphate], or oligomeric phosphoric acid ester compounds, but not limited thereto. They may be applied alone or in the form of a mixture of two or more.

The binder 373 may fill a plurality of voids (not shown) formed between contacts of the fire-resistant particles 371 and coat the outer surface of the insertion member 370.

In addition, the battery pack 300 may further include a controller 395 for controlling the plurality of battery cells 110. The controller 395 may be located between the power connection 393 (see FIG. 2) and the second busbar 391 (see FIG. 2). The controller 395 detects the voltage, current or temperature of the plurality of battery cells 110 and may control the charging and discharging of the plurality of battery cells 110.

FIG. 6 is an example of a side view of the battery pack 300 according to the present disclosure.

Referring to FIG. 6, the member accommodation space 383 may include a second member accommodation space 383b located between the plurality of battery cells 110 and the pack cover 315, and a third member accommodation space 383c located between the plurality of battery cells 110 and the partition 330.

Further, the member accommodation space 383 may further include a sub member accommodation space 383d located between the plurality of battery cells 110, the second insertion member 3702, and the partition 330.

In addition, the member accommodation space 383 may include a recessed accommodation space 383e formed in a recessed part 3195 formed by at least a portion of the pack cover 315 being recessed in a direction away from the pack body 319.

In addition, the member accommodation space 383 may further include a controller accommodation space 383f in which the controller 395 is located between the pack case 310 and the partition 330.

And the insertion member 370 may be inserted into each of the second member accommodation space 383b, the third member accommodation space 383c, the sub member accommodation space 383d, the recessed accommodation space 383e, and/or the controller accommodation space 383f.

Specifically, the insertion member 370 may further include the second insertion member 3702 located in the second member accommodation space 383b and formed in a different shape from the first insertion member 3701.

In addition, the insertion member 370 may further include a third insertion member 3703 located in the third member accommodation space 383c, and formed by the binder 373 but formed in a different shape from the first insertion member 3701 and the second insertion member 3702.

In addition, the insertion member 370 may further include a sub insertion member 3704 located in the sub member accommodation space 383d but formed in a different shape from the first insertion member 3701 and the second insertion member 3702.

The insertion member 370 may include a cover insertion member 3705 located in the recessed accommodation space 383e to surround at least a part of a detector detecting the current of the plurality of battery cells 110.

Further, the insertion member 370 may further include a controller insertion member 3706 located in the controller accommodation space 383f to surround at least a part of the controller 395.

In other words, a plurality of the insertion members 370 may be provided, and the plurality of insertion members 3701 to 3706 may be formed in different shapes depending on their locations.

Referring to FIGS. 1 and 6, the battery pack 300 may further include a power connection which is inserted through any side surface of the first pack body side surface 3301c, the second pack body side surface 3301d, the first pack connection side surface 3301a, and the second pack connection side surface 3301b and electrically connects the plurality of battery cells 110 to the outside, and the controller 395 which is located between the one side surface (3301a, 3301b, 3301c, 3301d) and the plurality of battery cells 110 and controls the plurality of battery cells 110.

The controller accommodation space 383f refers to the remaining space except the space occupied by the controller 395, and the controller insertion member 3706 may be located in the controller accommodation space 383f to surround at least a part of the controller 395.

FIG. 7 is an example of the insertion member 370 according to the present disclosure.

Specifically, FIG. 7 shows an example of how to assemble the battery pack 300 by settling the insertion member 370 to the member accommodation space 383. FIGS. 5 and 6 illustrate the member accommodation space 383 and the insertion member 370 in a simplified manner for explanation. Therefore, actually, it may be difficult to position the insertion member 370 having a shape that fits the member accommodation space 383 in the member accommodation space 383 due to interference with other members.

For example, the battery pack 300 may further include wiring 399 connecting the plurality of battery cells 110, a detector 397, and the controller 395. In the case that the wiring 399 is located in any one of the member accommodation spaces 383, it may be difficult to simply fit the insertion member 370 that matches the shape of the space.

In other words, due to the volume occupied by the wiring 399 in the member accommodation space 383, interference with the wiring 399 may occur at the time of insertion of the insertion member 370. Accordingly, the insertion member 370 may not be formed integrally so that the shape of the member accommodation space 383 corresponding to the insertion member 370 matches, but may be formed of multiple parts in consideration of interference with the wiring 399.

In other words, the insertion member 370 may be formed by combining a plurality of parts 370a and 370b.

Referring to FIG. 7, in the case that the insertion member 370 cannot be simply inserted from top to bottom due to interference of the wiring 399, the insertion member 370 may be formed by combining the first part 370a and the second part 370b which may be combined with the first part 370a to form a passage through which the wiring 399 passes. This may be applied equally to all of the insertion members.

FIG. 8 is another example of the insertion member 370 according to the present disclosure.

The insertion member 370 needs to have a shape corresponding to the member accommodation space 383 in order to be placed in the member accommodation space 383 or needs to be deformed in response to the shape of the member accommodation space 383.

To this end, the insertion member 370 may be formed to have a shape corresponding to the member accommodation space 383 as the plurality of fire-resistant particles 371 are bonded by the binder 373.

Alternately, the insertion member 370 may further include the exterior material 372 which accommodates the fire-resistant particle 371. In other words, the fire-resistant particle 371 may be accommodated in the exterior material 372 which restricts the movement of the fire-resistant particle 371 without the binder 373.

Further, the exterior material 372 may be formed of a material and thickness which may have a preset three-dimensional shape or outer shape. For example, the exterior material 372 may be formed from a polymer material such as polypropylene (PP) or polyethylene (PE).

FIG. 8 illustrates the insertion member 370 using FIG. 7 as an example, but the feature of the fire-resistant particle 371 being accommodated in the exterior material 372 may be applied to all other types of insertion member 370.

In other words, the first insertion member 3701, the second insertion member 3702, the third insertion member 3703, the sub insertion member 3704, the cover insertion member 3705, and the controller insertion member 3706 may also be in the form of the fire-resistant particles 371 and the exterior material 372 which accommodates the fire-resistant particles 371.

Further, when the internal temperature of the battery pack 300 is increased by the thermal runaway of the battery cell 110, the exterior material 372 may be melted, and the fire-resistant particles 371 accommodated inside the exterior material 372 may be exposed.

For this purpose, the melting point of the fire-resistant particle 371 shall have to be higher than the allowable temperature. In other words, the melting point of the fire-resistant particle 371 may be higher than the temperature at which the exterior material 372 begins to melt.

Accordingly, the melting point of the fire-resistant particle 371 may preferably be higher than a preset allowable temperature (or predetermined temperature) described below. Alternately, the exterior material 372 may begin to melt when the allowable temperature is reached. For example, the allowable temperature may be between 60° C. and 800° C.

As another example, the allowable temperature may be 200° C.

In the present disclosure, the allowable temperature of the exterior material 372 and the allowable temperature of the binder 373 are described as being within the same range. However, the allowable temperature of the exterior material 372 and the allowable temperature of the binder 373 may overlap only in a part of the range, and the upper or lower limit temperature may be different from each other.

FIG. 9 is another example of the insertion member 370 according to the present disclosure.

Referring to FIG. 9, the exterior material 372 may be formed of a flexible material. In other words, unlike FIG. 8, the exterior material 372 may be formed of a flexible material which is deformable in response to the space in which the insertion member 370 is located.

For example, the exterior material 372 may be formed of polypropylene (PP) or polyethylene (PE) material, but the thickness of the exterior material 372 may be smaller than a thickness capable of forming the three-dimensional shape, so that it can have flexibility.

Therefore, the insertion member 370 may be deformed according to the member accommodation space 383 in which the insertion member 370 is placed when assembling the battery pack 300.

In other words, the insertion member 370 may be deformed and arranged according to the shape of the first member accommodation space 383a, and the second member accommodation space 383b, the third member accommodation space 383c, the sub member accommodation space 383d, the recessed accommodation space 383e, and the controller accommodation space 383f.

The present disclosure may be embodied in various forms and is not limited to the above-described embodiments. Therefore, if a modified embodiment includes a component of the claims of the present disclosure, it should be considered to fall within the scope of the present disclosure.

What is claimed is:

1. A battery pack comprising:
a plurality of battery cells;
a pack case which accommodates the plurality of battery cells;
a partition located inside the pack case and dividing an internal space of the pack case to form a cell accommodation space in which the plurality of battery cells are accommodated;
a member accommodation space located adjacent to the cell accommodation space within the pack case; and
an insertion member located in the member accommodation space and comprising fire-resistant particles.

2. The battery pack according to claim 1, wherein the insertion member further comprises a binder which binds the fire-resistant particles together.

3. The battery pack according to claim 2, wherein the binder melts above a predetermined allowable temperature, and
the allowable temperature is between 60° C. (degree Celsius) and 800° C.

4. The battery pack according to claim 3, wherein a melting point of the fire-resistant particles is higher than the allowable temperature.

5. The battery pack according to claim 2, wherein the fire-resistant particles are bound by the binder to form an outer shape of the insertion member.

6. The battery pack according to claim 1, wherein the insertion member further comprises an exterior material which accommodates the fire-resistant particles.

7. The battery pack according to claim 6, wherein the exterior material melts above a predetermined allowable temperature, and
the allowable temperature is between 60° C. and 800° C.

8. The battery pack according to claim 6, wherein the exterior material is formed into a predetermined shape.

9. The battery pack according to claim 6, wherein the exterior material is formed of a flexible material which is deformable according to a space in which the insertion member is disposed.

10. The battery pack according to claim 1, wherein the fire-resistant particles comprise a porous material, and a porosity of the porous material is 1% (percent) or more and 99% or less.

11. The battery pack according to claim 1, wherein the fire-resistant particles comprise one of silicon dioxide and an organic silicon compound or a combination thereof.

12. The battery pack according to claim 1, wherein the pack case comprises:
a pack body having an opening in an upper part, accommodating the plurality of battery cells through the opening, and forming the cell accommodation space and the member accommodation space together with the partition; and
a pack cover which is coupled to the pack body to close the opening.

13. The battery pack according to claim 12, wherein the pack body comprises:
a pack body bottom surface forming a bottom surface of the pack body; and
a pack body side part which extends from an edge of the pack body bottom surface and extends toward the pack cover.

14. The battery pack according to claim 13, wherein the member accommodation space comprises a first member accommodation space formed by the plurality of battery cells and the pack body side part, and
the insertion member comprises a first insertion member which is located in the first member accommodation space.

15. The battery pack according to claim 14, wherein the member accommodation space further comprises a second member accommodation space located between the plurality of battery cells and the pack cover, and
the insertion member further comprises a second insertion member located in the second member accommodation space and formed in a different shape from the first insertion member.

16. The battery pack according to claim 15, wherein the member accommodation space further comprises a third member accommodation space located between the plurality of battery cells and the partition, and
the insertion member further comprises a third insertion member located in the third member accommodation space and formed in a different shape from the first insertion member and the second insertion member.

17. The battery pack according to claim 15, wherein the member accommodation space further comprises a sub member accommodation space located between the plurality of battery cells, the second insertion member, and the partition, and
the insertion member further comprises a sub insertion member located in the sub member accommodation space and formed in a different shape from the first insertion member and the second insertion member.

18. The battery pack according to claim 13, wherein the pack body side part comprises:
a first pack body side surface and a second pack body side surface extending from a pair of edges facing each other among edges of the pack body bottom surface toward the pack cover; and
a first pack connection side surface and a second pack connection side surface which are connected to the first pack body side surface and the second pack body side surface and extend from another pair of edges facing each other of the pack body bottom surface toward the pack cover.

19. The battery pack according to claim 1, wherein a volume occupied by the fire-resistant particles is 1% or more of the volume of the member accommodation space.

20. The battery pack according to claim 1, wherein a plurality of the insertion members are provided, and
the plurality of insertion members are formed into different shapes depending on their locations.
